(19) United States
(12) Patent Application Publication
(10) Pub. No.: US 2013/0057432 A1
(43) Pub. Date: Mar. 7, 2013

(54) METHOD AND APPARATUS FOR BEAM BROADENING FOR PHASED ANTENNA ARRAYS USING MULTI-BEAM SUB-ARRAYS

(71) Applicants: Sridhar Rajagopal, Plano, TX (US); Kaushik Josiam, Dallas, TX (US); Zhouyue Pi, Allen, TX (US)

(72) Inventors: Sridhar Rajagopal, Plano, TX (US); Kaushik Josiam, Dallas, TX (US); Zhouyue Pi, Allen, TX (US)

(73) Assignee: Samsung Electronics Co., Ltd., Suwon-si (KR)

(21) Appl. No.: 13/558,208

(22) Filed: Jul. 25, 2012

Related U.S. Application Data
(60) Provisional application No. 61/530,790, filed on Sep. 2, 2011.

(51) Int. Cl. H01Q 3/24

(52) U.S. Cl. 342/368

(57) ABSTRACT

A transmitter or receiver may use beamforming methods for transmitting or receiving a signal in a communication system. The method for transmitting includes determining a first beamforming weight associated with a total number of antennas in an antenna array. The method also includes transmitting a first signal in a first beam having a first beam width using the total number of antennas by applying the first predetermined beamforming weight. The method further includes determining a second beamforming weight associated with a first sub-array of antennas in the antenna array and determining a third beamforming weight associated with a second sub-array of antennas in the antenna array. The method still further includes transmitting a second signal in a second beam having a second beam width using the first sub-array of antennas by applying the second beamforming weight and the second sub-array of antennas by applying the third beamforming weight.

### CROSS-REFERENCE TO RELATED APPLICATION(S) AND CLAIM OF PRIORITY

The present application is related to U.S. Provisional Patent Application No. 61/530,790, filed Sep. 2, 2011, entitled “METHOD AND APPARATUS FOR BEAM BROADENING FOR PHASED ANTENNA ARRAYS USING MULTI-BEAM SUBARRAYS”. Provisional Patent Application No. 61/530,790 is assigned to the assignee of the present application and is hereby incorporated by reference into the present application as if fully set forth herein. The present application hereby claims priority under 35 U.S.C. §119(e) to U.S. Provisional Patent Application No. 61/530,790.

### TECHNICAL FIELD

The present application relates generally to wireless communications and, more specifically, to a method and apparatus for beam broadening for phased antenna arrays using multi-beam sub-arrays.

### BACKGROUND

Mobile communication has been one of the most successful innovations in modern history. Recently, the number of subscribers to mobile communication services exceeded five billion and continues to grow quickly. At the same time, new mobile communication technologies are being developed to satisfy the increasing demand and to provide more and better mobile communication applications and services. Some examples of such systems are cdma2000 and 1xEV-DO systems developed by 3GPP2; WCDMA, HSPA, and LTE systems developed by 3GPP; and mobile WiMAX systems developed by IEEE. As more and more people become users of mobile communication systems, and more and more services are provided over these systems, there is an increasing need for mobile communication systems with larger capacity, higher throughput, lower latency, and better reliability.

### SUMMARY

A method for transmitting a signal to at least one receiver using multiple beam widths is provided. The method includes determining a first beamforming weight associated with a total number of antennas in an antenna array. The method also includes transmitting a first signal in a first beam having a first beam width using the total number of antennas by applying the first predetermined beamforming weight. The method further includes determining a second beamforming weight associated with a first sub-array of antennas in the antenna array and determining a third beamforming weight associated with a second sub-array of antennas in the antenna array. The method still further includes transmitting a second signal in a second beam having a second beam width using the first sub-array of antennas by applying the second beamforming weight and the second sub-array of antennas by applying the third beamforming weight.

For use in a wireless network, a transmitter capable of communicating with a plurality of receivers is provided. The transmitter includes an antenna array comprising a plurality of antennas, and a transmit path. The transmit path is configured to determine a first beamforming weight associated with a total number of antennas in the antenna array. The transmit path is also configured to transmit a first signal in a first beam having a first beam width using the total number of antennas by applying the first predetermined beamforming weight. The transmit path is further configured to determine a second beamforming weight associated with a first sub-array of antennas in the antenna array and determine a third beamforming weight associated with a second sub-array of antennas in the antenna array. The transmit path is still further configured to transmit a second signal in a second beam having a second beam width using the first sub-array of antennas by applying the second beamforming weight and the second sub-array of antennas by applying the third beamforming weight.

For use in a wireless network, a receiver capable of communicating with a plurality of transmitters is provided. The receiver includes an antenna array comprising a plurality of antennas, and a receive path. The receive path is configured to determine a first beamforming weight associated with a total number of antennas in the antenna array. The receive path is also configured to receive a first signal in a first beam having a first beam width using the total number of antennas by applying the first predetermined beamforming weight. The receive path is further configured to determine a second beamforming weight associated with a first sub-array of antennas in the antenna array and determine a third beamforming weight associated with a second sub-array of antennas in the antenna array. The receive path is still further configured to receive a second signal in a second beam having a second beam width using the first sub-array of antennas by applying the second beamforming weight and the second sub-array of antennas by applying the third beamforming weight.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless communication network according to embodiments of this disclosure;

FIG. 2 illustrates a high-level diagram of an orthogonal frequency division multiple access (OFDMA) or millimeter wave transmit path according to an embodiment of this disclosure;

FIG. 3 illustrates a high-level diagram of an OFDMA or millimeter wave receive path according to an embodiment of this disclosure;

FIG. 4 illustrates a phased antenna array architecture in accordance with embodiments of this disclosure;

FIG. 5 shows a signal model of an antenna array according to embodiments of this disclosure;

FIG. 6 illustrates sub-array addition in an 8-element antenna array with two sub-arrays;

FIG. 7 illustrates a comparison between flipping and conjugation for two sub-arrays;

FIG. 8 illustrates an example of beam broadening with 256 elements and eight sub-arrays;

FIG. 9 illustrates the resultant broadened beam after summation for the example shown in FIG. 8;

FIG. 10 illustrates an example of a broadened beam generated at boresight and then steered at two angles;

FIG. 11 illustrates a default ripple for a sixteen element array with M=2;

FIG. 12 illustrates increasing the beam placement to achieve an optimum ripple;

FIG. 13, illustrates further increasing the beam direction to decrease the ripple;

FIG. 14 illustrates a default array response for an 8×8 antenna array;

FIG. 15 illustrates beam broadening for the 8×8 array using four sub-arrays;

FIG. 16 illustrates a method associated with a beam broadening algorithm according to an embodiment of this disclosure;

FIG. 17 illustrates a procedure for beam broadening to be performed at the base station and mobile station, according to an embodiment of this disclosure;

FIGS. 18 and 19 illustrate two example applications of antenna sub-arrays according to embodiments of this disclosure;

FIG. 20 illustrates an example of a beam broadening application for a beacon transmission according to an embodiment of this disclosure;

FIG. 21 illustrates an application of beam broadening to support multiple ray reception at a receiver, in accordance with an embodiment of this disclosure;

FIG. 22 illustrates an arrangement in which different beam widths are supported in a codebook, in accordance with an embodiment of this disclosure;

FIG. 23 illustrates a codebook selection procedure in accordance with one embodiment of this disclosure;

FIG. 24 illustrates a codebook selection procedure with UE decision and signaling, in accordance with one embodiment of this disclosure;

FIG. 25 illustrates a codebook selection procedure with UE signaling and BS decision, in accordance with one embodiment of this disclosure;

FIG. 26 illustrates an application of spectral null placement by beam broadening, in accordance with an embodiment of this disclosure;

FIG. 27 illustrates the use of a digital precoder to refine beams while sub-arrays are used for beam broadening, in accordance with an embodiment of this disclosure;

FIG. 28 illustrates a multi-resolution codebook structure and associated feedback, in accordance with an embodiment of this disclosure; and

FIG. 29 illustrates the frequency of precoder updates, in accordance with an embodiment of this disclosure.

### DETAILED DESCRIPTION

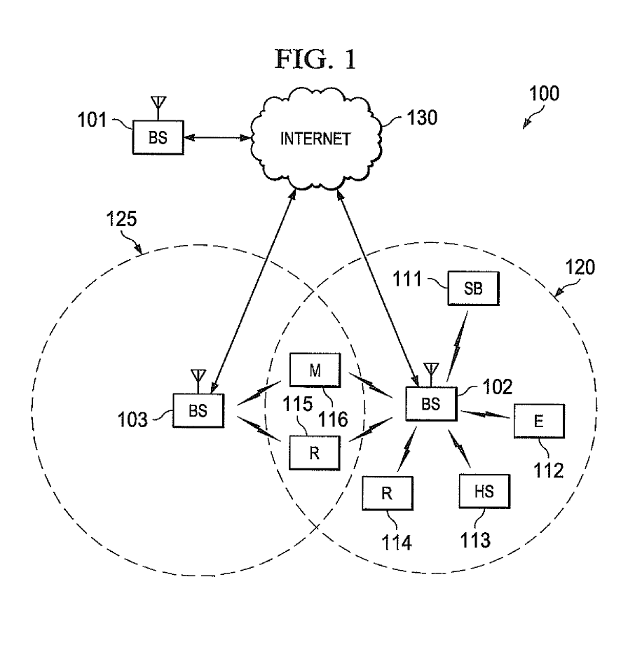

FIGS. 1 through 29, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents and standards descriptions are hereby incorporated into the present disclosure as if fully set forth herein:
Z. Pi, F. Khan, “An introduction to millimeter-wave mobile broadband systems,” IEEE Communications Magazine, vol. 49, no. 6, pp. 101-107, June 2011 (hereinafter “REF1”);
Cisco white paper, “Cisco Visual Networking Index: Forecast and Methodology,” June 2010, available at http://www.cisco.com/ (hereinafter “REF2”);
A. Ghosh, R. Ratasuk, B. Mondal, N. Mangalvedhe, T. Thomas, “LTE-advanced: Next-generation Wireless Broadband Technology [Invited Paper]”, Wireless Communications, IEEE, vol. 17, no. 3, pp. 10-22, June 2010 (hereinafter “REF3”);
E. Perahia, C. Cordeiro, M. Park, L. Yang, “IEEE 802.11ad: Defining the Next Generation Multi-Gbps Wi-Fi”, 7th IEEE Consumer Communications and Networking Conference (CCNC), 2010, pp. 1-5, January 2010 (hereinafter “REF4”);
S. Orfanidis, “Electromagnetic Waves and Antennas”, available at http://www.ece.rutgers.edu/-orfanidi/ewa (hereinafter “REF5”);
C. Doan, S. Emami, A. Niknejad, R. Brodersen, “Millimeter-Wave CMOS Design,” IEEE Journal of Solid-State Circuits, vol. 40, no. 1, pp. 144-155, January 2005 (hereinafter “REF6”);
M. Tabesh, J. Chen, C. Marcu, L. Kong, S. Kang, E. Alon, A. Niknejad, “A 65 nm CMOS 4-Element Sub-34mW/Element 60 GHz Phased Array Transceiver,” IEEE International Solid-State Circuits Conference (ISSCC), pp. 12-14, March 2011 (hereinafter “REF7”);
I. Lakkis, S. Kato, S. Yong, P. Xia, “mmWave Multi-Resolution Beamforming,” IEEE 802.15-08-0182-00-003c, January 2008 (hereinafter “REF8”);
J. Wang, Z. Lan, C. Pyo, T. Baykas, C. Sum, A. Rahman, R. Funada, F. Kojima, I. Lakkis, H. Harada, S. Kato, “Beam Codebook Based Beamforming Protocol for Multi-Gbps Millimeter-Wave WPAN Systems,” IEEE Global Telecommunications Conference, 2009, pp. 1-6 (hereinafter “REF9”);
K. Ramachandran, N. Prasad, K. Hosoya, K. Maruhashi, S. Rangarajan, “Adaptive Beamforming for 60 GHz Radios: Challenges and Preliminary Solutions”, Proceedings of the 2010 ACM International Workshop on mmWave Communications: From Circuits to Networks (mmCom '10), ACM, New York, N.Y., USA, pp. 33-38 (hereinafter “REF10”);
US Patent Publication No. US 2009/0232245 to Lakkis, titled “Multi-Resolution Beamforming Based on Codebooks in MIMO systems”, published Sep. 17, 2009 (hereinafter “REF11”);
C. Kerce, G. Brown, M. Mitchell, “Phase-Only Transmit Beam Broadening for Improved Radar Search Performance”, IEEE Radar Conference, pp. 451-456, April 2007 (hereinafter “REF12”);
H. Lebret, S. Boyd, “Antenna Array Pattern. Synthesis via Convex Optimization”, IEEE Transactions on Signal Processing, vol. 45, no. 3, pp. 526-532, March 1997 (hereinafter “REF13”);
G. Kautz, “Phase-only Shaped Beam Synthesis via Technique of Approximated Beam Addition”, IEEE Transactions on Antennas and Propagation, vol. 47, no. 5, pp. 887-894, May 1999 (hereinafter “REF14”);
H. Krishnaswamy and H. Hashemi, “Integrated Beamforming Arrays”, in “mm-Wave Silicon Technology: 60 GHz and Beyond”, Springer, January 2008 (hereinafter “REF15”);
G. Shaw and R. Dybdal, “Beam Broadening for Active Aperture Antennas,” IEEE Antennas and Propagation Society International Symposium, pp. 134-137, vol. 1, Jun. 1989 (hereinafter “REF16”);
R. Young, “Antenna Pattern Control by Phase-Only Weighting”, IEEE Colloquium on Phased Arrays, vol. 5, pp. 1-7, December 1991 (hereinafter “REF17”).

Recently, interest has grown in exploring millimeter wave (mmWave) frequencies for outdoor, mobile broadband communication for multi-Gb/s communication over several hundreds of meters (see also REF1). The current system implementations of 3G/4G cellular standards, such as LTE-A, are largely close to capacity, making it difficult to meet the ever-increasing demands of higher data rate communication with the limited spectrum available below 3 GHz (see also REF2 and REF3). Communication using higher mmWave frequencies provides access to potentially multiple GHz of spectrum bandwidth, thereby enabling multi-Gb/s communication.

Millimeter waves typically refer to radio waves with wavelengths in the range of 1 mm-10 mm, which corresponds to a radio frequency of 30 GHz-300 GHz. These radio waves exhibit unique propagation characteristics. For example, systems using higher millimeter wave (mmWave) frequencies for traditional outdoor mobile communication systems have been associated with challenges, such as Line Of Sight (LOS) directional communication, poor RF efficiency and higher path loss. Hence, these frequencies have been primarily deployed for wireless backhaul with fixed LOS transmitters and receivers, Recently, however, there has been an increased interest in using mmWave frequencies for short range, non-LOS (NLOS) communication with multi-Gbps data rates, especially at 60 GHz (see also REF4). These systems are equipped with large antenna arrays to support beamforming, which compensates for the path loss and enables NLOS communication for stationary users over short distances.

For a given linear antenna array of size N, the gain is proportional to 10×log 10(N) dB (see also REF5). However, the half power beam width (HPBW) is inversely proportional to N. Thus, large antenna arrays can provide good beamforming gains but may have a very narrow beam width. This tradeoff between beamforming gain and the width of the beam can give rise to the following three challenges for the system design.

1. Traditional communication system design with omni-directional transmissions are great for control and broadcast data to all users. However, they are often inefficient for user-specific data communication since the energy is sent in all directions. Directional communication in the mmWave frequencies is often associated with the converse problem, in that directionality can be advantageous for user-specific data communication, but the control and broadcast channel design for multiple users can be challenging. For broadcast or control data, coverage is important, which results in a large beam width. Additionally, broadcast/control channels can function with a low signal-to-noise ratio (SNR) and high beamforming gain is not required. For user specific data, a high beamforming gain can be utilized to provide multi-Gb/s data rates. User specific data is sent to a specific user in a specific direction, thus, narrow beams are acceptable. Accordingly, with the same antenna array, both narrow and wide beam widths may be desired.

2. For user-specific communication, the user may be mobile. Thus, the channel may have variations due to fading or blocking. Therefore, a very narrow beam may not be desired in all cases for reliability and mobility support.

3. The HPBW from an antenna array is not uniform. It can be shown that the HPBW changes from broadside to end-fire approximately as \sqrt{2N}.

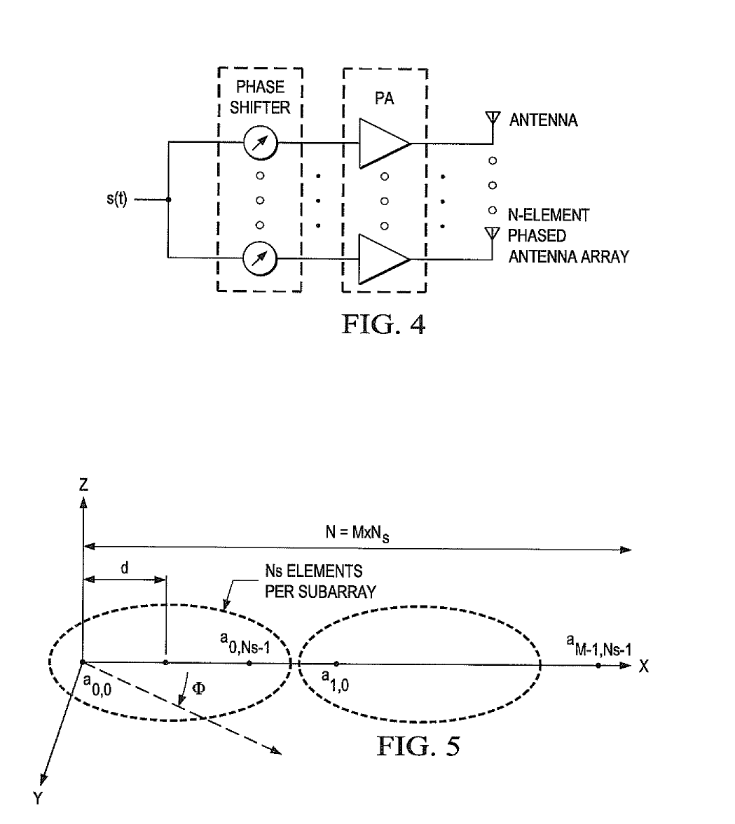

FIG. 4 illustrates a phased antenna array architecture in accordance with embodiments of this disclosure. The embodiment of the phased antenna array illustrated in FIG. 4 is for illustration only. Other embodiments of the phased antenna array could be used without departing from the scope of this disclosure.

The efficiency of RF components can be poor at mmWave frequencies (see REF4). In some phased antenna array designs (see, e.g., REF7), the RF power amplifiers (PA) operate at maximum power, and a separate phase shifter and PA are provided for each individual antenna element in the array. Thus, any control of the array is typically managed using the phase shifters without any change in the amplitude to minimize power loss.

There are a number of options to broaden the beam with such a unit amplitude constraint. One option is to turn off parts of the antenna array. However, this results in a loss in output power in addition to the beamforming loss due to the smaller element array. There has been research in designing multiple resolution beams for 60 GHz systems in which larger beams are used for control channels and narrower beams are used for data channels (see, e.g., REF8, REF9, REF10, REF11). These methods do not actually “broaden” the beam width, but instead send multiple beams.

There has also been research in phase-only beam broadening (see, e.g., REF12, REF13, REF14). However, those methods are based on searches and do not provide a systematic approach for beam broadening. REF13 has shown that phase-only constrained weight search is not a convex optimization problem, making solutions approximate or difficult to develop. Architectures with multiple phase shifters and combiners per antenna elements, as described in REF15, are not required for multi-beam support. There has also been research for beam broadening with multiple sub-arrays where the sub-array spacing is increased to improve the beam width and the sub-arrays are interleaved in order to minimize grating lobes (see, e.g., REF16, REF17).

Accordingly, embodiments of this disclosure provide a systematic approach for beam broadening for phased antenna arrays by breaking the antenna array into multiple logical sub-arrays. The sub-arrays are spaced contiguously without any spacing increase or formation of grating lobes. REF5 provides a description of basic theory for beam broadening allowing for amplitude variations. This disclosure develops the basic theory of beam broadening for phased antenna arrays using such multiple sub-arrays.

It is noted that, although embodiments of this disclosure are described in accordance with millimeter wave communication, the embodiments of this disclosure are certainly applicable in other communication mediums, e.g., radio waves with frequency of 3 GHz-30 GHz that exhibit similar properties as millimeter waves. Although this disclosure describes the use of mmWave as an example of communication systems with large antenna arrays, these concepts can also be applied at lower frequencies at 2 GHz for upcoming technologies such as massive MIMO with large number of antenna arrays. Additionally, some embodiments of this disclosure are also applicable to electromagnetic waves with terahertz frequencies, infrared, visible light, and other optical media.

FIG. 1 illustrates a wireless communication network, according to embodiments of this disclosure. The embodiment of wireless communication network 100 illustrated in FIG. 1 is for illustration only. Other embodiments of the wireless communication network 100 could be used without departing from the scope of this disclosure.

In the illustrated embodiment, the wireless communication network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based system (not shown).

Base station 102 provides wireless broadband access (via base station 101) to Internet 130 to a first plurality of subscriber stations (also referred to herein as mobile stations) within coverage area 120 of base station 102. The first plurality of subscriber stations includes subscriber station 111, which may be located in a small business (SB), subscriber station 112, which may be located in an enterprise (E), subscriber station 113, which may be located in a WiFi hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In accordance with embodiments of this disclosure, base stations 101-103 may communicate with each other and with subscriber stations 111-116 using OFDM, OFDMA, or millimeter wave techniques. Further in accordance with embodiments of this disclosure, each of base stations 101-103 may transmit through a phased antenna array that may be configured into a plurality of sub-arrays.

While only six subscriber stations are depicted in FIG. 1, it is understood that the wireless communication network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. For example, subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

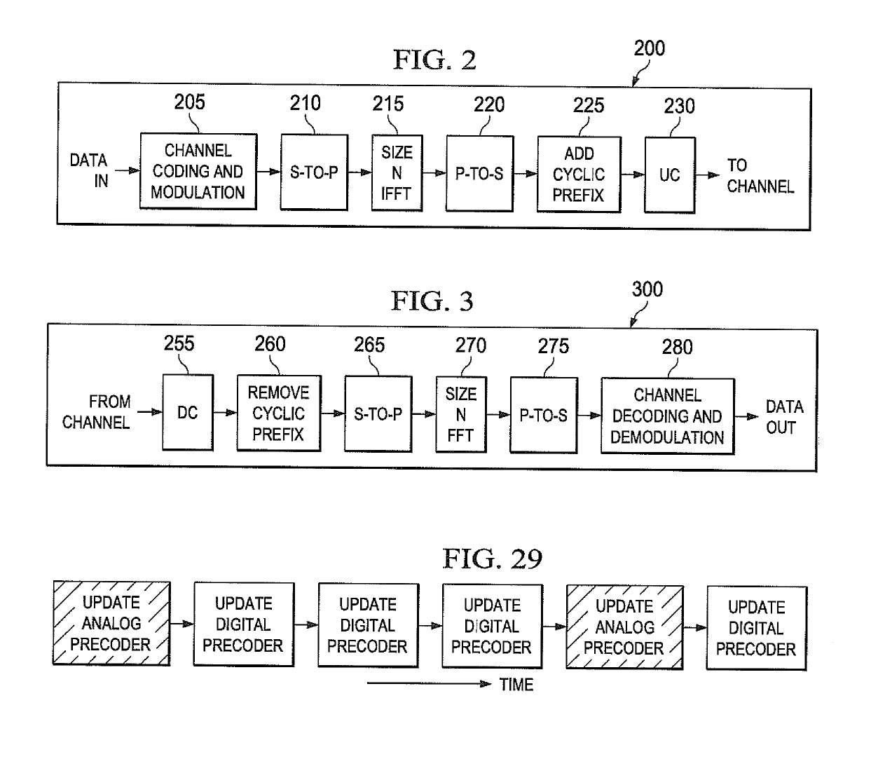

FIG. 2 is a high-level diagram of an orthogonal frequency division multiple access (OFDMA) or millimeter wave transmit path. FIG. 3 is a high-level diagram of an OFDMA or millimeter wave receive path. In FIGS. 2 and 3, the transmit path 200 may be implemented, e.g., in base station (BS) 102 and the receive path 300 may be implemented, e.g., in a subscriber station, such as subscriber station 116 of FIG. 1. It will be understood, however, that the receive path 300 could be implemented in a base station (e.g. base station 102 of FIG. 1) and the transmit path 200 could be implemented in a subscriber station.

Transmit path 200 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. Receive path 300 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2 and 3 may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 200, channel coding and modulation block 205 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

FIG. 5 shows a signal model of an antenna array according to embodiments of this disclosure. The embodiment of the antenna array illustrated in FIG. 5 is for illustration only. Other embodiments of the antenna array could be used without departing from the scope of this disclosure.

The array may be a uniform linear array of N=M×Nₛ isotropic antenna elements, where M is the number of sub-arrays and Nₛ is the number of elements per sub-array. For the purpose of the following explanation, several assumptions are made. Let the antenna spacing be d. Let the phased antenna weights be given by a_{m,n}, where m is the sub-array index and n is the element index within each sub-array. Let Φ be the azimuthal angle over which the array is steered. Further, let Ψ=kd cos(Φ) be the psi-space corresponding to the angle space, where k=2π/λ and λ is the wavelength. The array factor can be given by:

$$A ( ψ ) = {\sum }_{m = 0}^{M - 1} {\sum }_{n = 0}^{{N}_{s} - 1} {a}_{m , n} {e}^{j ψ ( {mN}_{s} + n )} \qquad [ Eqn . 1 ]$$

Let the individual sub-array responses be given by:

$${A}_{m} ( ψ ) = {\sum }_{n = 0}^{{N}_{s} - 1} {a}_{m , n} {e}^{j ψ n} \qquad [ Eqn . 2 ]$$

And let each sub-array Aₘ(ψ) be pointed in a particular azimuthal angle Ψₘ. Then the resultant sub-array factors can be given by:

$${A}_{m} ( ψ ) = {\sum }_{n = 0}^{{N}_{s} - 1} {e}^{j ( ψ - {ψ}_{m} ) n} \qquad [ Eqn . 3 ]$$

From Equations (1) and (3), the resultant array factor can be given by:

$$\begin{matrix}A ( ψ ) = {\sum }_{m = 0}^{M - 1} {e}^{j ψ {mN}_{s}} {A}_{m} ( ψ ) & [ Eqn . 4 ] \\ A ( ψ ) \leq {\sum }_{m = 0}^{M - 1} \vert {A}_{m} ( ψ ) \vert & [ Eqn . 5 ]\end{matrix}$$

Equation (5) defines the support region for A(ψ). When multiple beams are added, the resulting beam is disposed in the region defined by the sum of all the beams. If the beam angles Ψₘ are placed outside the HPBW (Δφ_{3dB}^{N}^{ₛ}) of the individual sub-array factors, it is expected that there will be little or no interaction between the beams. Thus, architectures with multiple phase shifters and power combiners per antenna element, as described in REF15, are not required for multi-beam support.

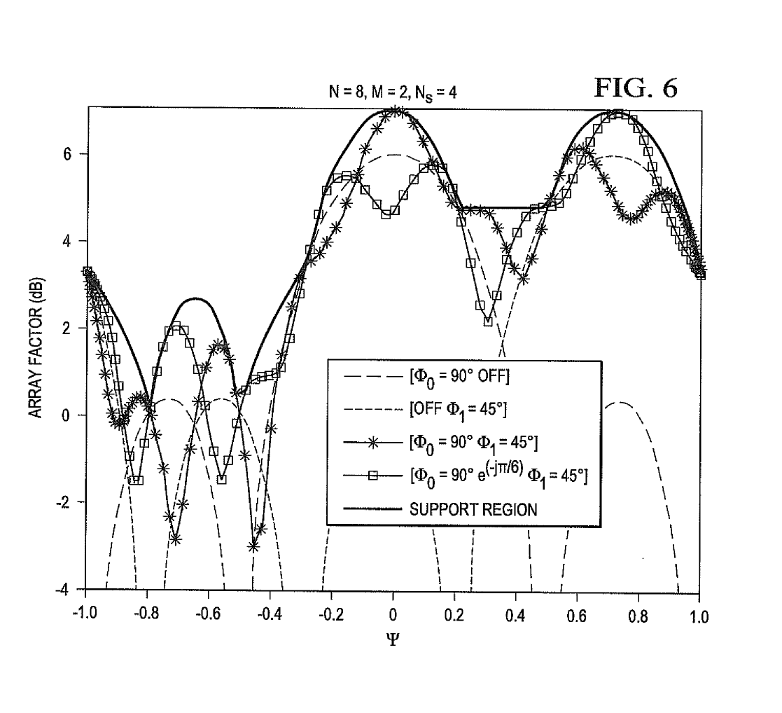

FIG. 6 illustrates sub-array addition in an 8-element antenna array with two sub-arrays (N=8, M=2) configured to transmit beams at 90° and 45°. The dotted curves show the individual sub-array responses when the other sub-array is turned OFF. The resultant array factor when both sub-arrays are active is shown as [Φ₀=75° Φ₁=105°]. A constant phase shift of n/6 is provided between sub-array weights (i.e., weights of only the second sub-array are multiplied by e^{-jπ/6}). This phase shift could be provided in the radio frequency (RF) domain itself using a single RF chain, or it can be provided by digital baseband precoding if both sub-arrays are connected to different RF chains. Thus, it is noted that the resultant array factor still lies within the support region. This provides insight into baseband precoder designs for such systems. If there are multiple antennas per RF chain, analog beamforming largely determines the support region, and digital beamforming allows limited beam shaping within the support region defined by the sub-arrays.

The following theorems may be used to describe principles of beam broadening. The proofs are provided at the end of this disclosure.

Theorem 1a: If the array weights are conjugated, the array response is flipped.

Let B(ψ) be the array factor of the resulting array with weights b_{m.n}=a_{m,n}*

if b_{m.n}=a_{m,n}*

|B(ψ)|=|A(−ψ)| [Eqn. 6]

Theorem 1b: If the array weights are flipped (mirrored), the array response is flipped.

if b_{m.n}=a_{M-1-m,N}_{_{S}}₋₁₋ₙ

|B(ψ)|=|A(−ψ)| [Eqn. 7]

Theorem 2: Flipped sub-array weights ensure a symmetric resultant array response regarding boresight but conjugating sub-array weights does not provide a symmetric response.

FLIP: if a_{m+M/2.n}=a_{M/2-1-m,N}_{_{S}}₋₁₋ₙm=0 . . . M/2−1

|Aᵢ(ψ)|=|Aⱼ(−ψ)|

|A(ψ)|=|A(−ψ)| [Eqn. 8]

CONJ: if a_{m+M/2.n}=a_{m,n}*m=0 . . . M/2−1

|Aᵢ(ψ)|=|Aⱼ(−ψ)|

|A(ψ)|≠|A(−ψ)| [Eqn. 9]

where Aᵢ(ψ) is the sub-array response whose weights are either flipped or conjugated from the sub-array Aⱼ(ψ) weights.

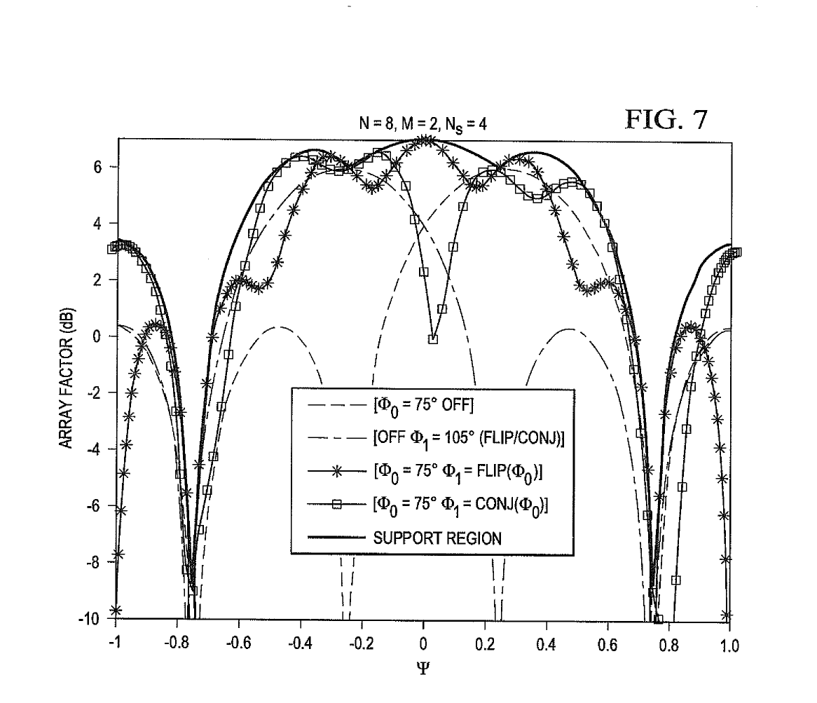

FIG. 7 illustrates a comparison between flipping and conjugation for two (2) sub-arrays. The first sub-array has weights targeted at Φ₀=75°. The weights for the second sub-array, which are targeted at Φ₁=105°, can be obtained either by flipping or conjugating the weights of the first sub-array. However, as can be seen from FIG. 7, flipping provides a symmetric response about boresight for the resultant array factor, while conjugation does not provide a symmetric response.

Theorem 3: If the antenna azimuthal angles are placed symmetrically about boresight and the weights for one half of the array are flipped with respect to the other half, the resultant array factor can be expressed as:

$$\begin{matrix} if {a}_{m , n} = {a}_{M - 1 - m , {N}_{s} - 1 - n} , \\ A ( ψ ) = {\sum }_{m = 0}^{M / 2 - 1} {e}^{j ( 2 m - 1 ) {N}_{s} - 1 ) {ψ}_{m}^{-}} ( \frac{sin ( {N}_{s} {ψ}_{m}^{-} )}{sin ( {ψ}_{m}^{-} )} + {e}^{j ( N - ( 2 m - 1 ) {N}_{s} ) ψ} \frac{sin ( {N}_{s} {ψ}_{m}^{+} )}{sin ( {ψ}_{m}^{+} )} ) & [ Eqn . 10 ] \\ where {ψ}_{m}^{-} = \frac{ψ - {ψ}_{m}}{2} and {ψ}_{m}^{+} = \frac{ψ + {ψ}_{m}}{2} . & \end{matrix}$$

Beam Broadening Algorithm

Based on the observations in the previous section, it is noted that beams that are spaced more than Δφ_{3dB}^{N}^{ₛ} apart may have little or no interaction between their individual array responses. It is also noted that flipping the array weights for sub-arrays provides a desirable symmetric response about boresight. In accordance with these observations, a beam broadening algorithm may be defined using sub-arrays with multiple beams. However, the number of sub-arrays needed, the placement of the beam directions for the sub-arrays, and the resulting HPBW Δφ_{3dB}^{MN}^{ₛ} the entire array, need to be determined.

In accordance with equation (10), the resultant array factor can be approximately viewed as a summation of sin c pulses and has minima at ψᵢ=±2πi/Nₛ. Drawing parallels from OFDM systems, where the subcarriers are placed at minima, the beams may be placed at:

$${ψ}_{m} = \pm \frac{( 2 m + 1 ) π}{{N}_{s}} ( m = 0 … M / 2 - 1 ) or \\ {φ}_{m} = {cos}^{- 1} ( \pm \frac{( 2 m + 1 ) π}{{kdN}_{s}} ) ( m = 0 … M / 2 - 1 ) \qquad [ Eqn . 11 ]$$

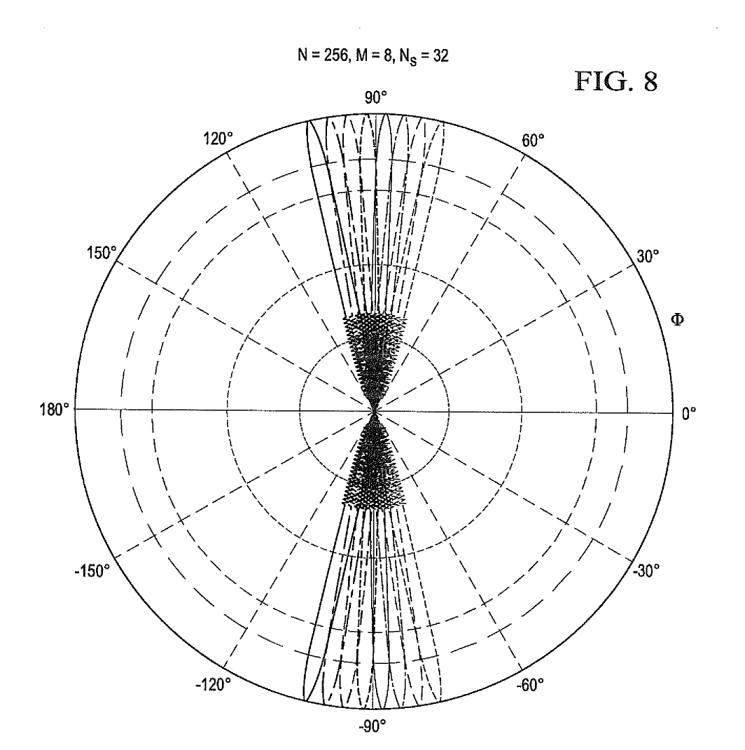

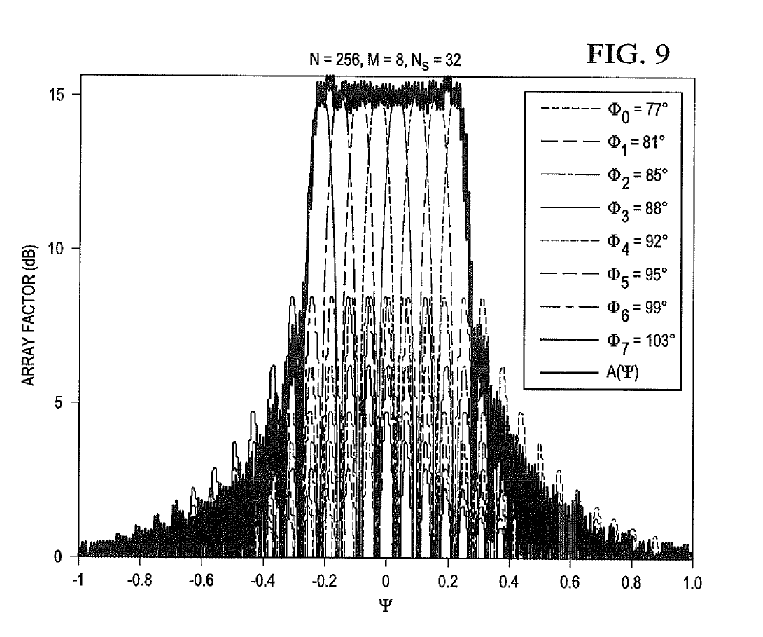

FIG. 8 illustrates an example of beam broadening with 256 elements and eight (8) sub-arrays. The beam directions are placed as given by equation (11). FIG. 9 illustrates the resultant broadened beam after summation for the example shown in FIG. 8. It can be seen that the resultant beam has been broadened by a factor of approximately M.

Thus, the resultant HPBW of the array can be written as:

Δφ_{3dB}^{MN}^{ₛ}=MΔφ_{3dB}^{N}^{ₛ} [Eqn. 12]

As discussed in REF9, the HPBW of each individual sub-array is inversely proportional to the number of elements in the sub-array Nₛ.

$$Δ {φ}_{3 dB}^{{N}_{s}} ≅ \frac{101.52 °}{{N}_{s} sin ( φ )} \qquad [ Eqn . 13 ]$$

Using equation (13) and factorizing N as N=M×Ns, the broadening factor due to each individual sub-array can be given by:

$$\frac{Δ {φ}_{3 dB}^{{N}_{s}}}{Δ {φ}_{3 dB}^{N}} = \frac{N}{{N}_{s}} = M \qquad [ Eqn . 14 ]$$

Thus, from equations (12) and (14), the broadening factor (BF) of the entire array is equal to the product of the number of sub-arrays and the broadening factor due to each sub-array.

$$BF = \frac{Δ {φ}_{3 dB}^{{MN}_{s}}}{Δ {φ}_{3 dB}^{N}} = {M}^{2} \qquad [ Eqn . 15 ]$$

For the example shown in FIG. 8 and FIG. 9, the beam is broadened from the natural beam width of approximately 0.4° to approximately 25.6°, providing a beam broadening factor of 64.

There may still be a ripple in the passband even for large values of N, although the ripple may decay to approximately zero as the value of N continues to increase, since the sin c functions become closer to impulses for large N. These overshoots are similar to Gibb's phenomenon, which is seen where the tail does not go to zero but to a constant for large N.

Beam Steering for Non-Boresight Directions

Although the defined algorithm broadens the beam only at boresight, it is easy to steer the beam for non-boresight directions by progressively phasing the boresight antenna weights. REF5 shows that the steered weights can be expressed as:

$${b}_{m , n} = {a}_{m , n} {e}^{- j ( {mN}_{s} + n - \frac{N - 1}{2} ) {ψ}_{m}} \qquad [ Eqn . 16 ]$$

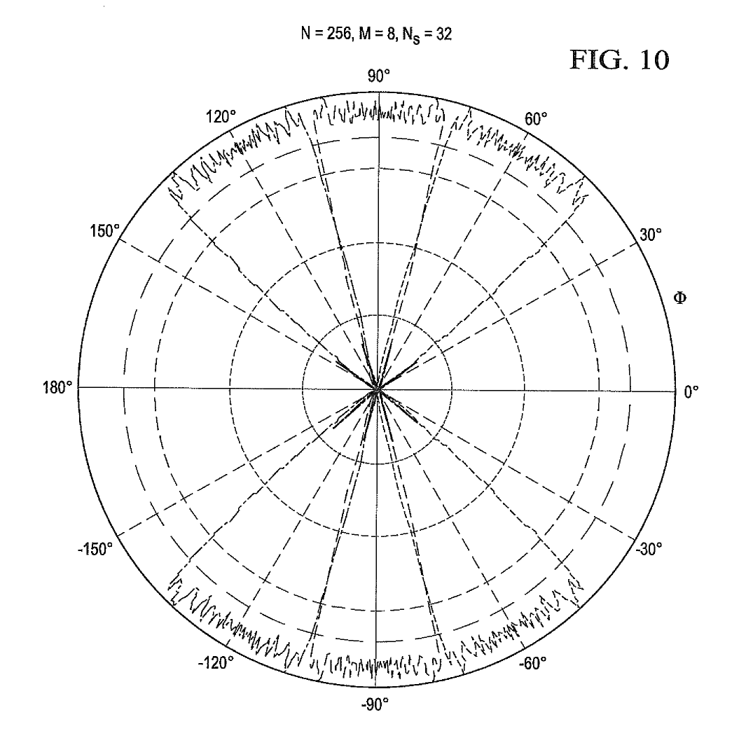

FIG. 10 illustrates an example of a broadened beam generated at boresight Φₘ=90° and then steered at angles Φₘ=60° and 120° using equation (16). It can be seen that the beam away from boresight becomes broadened as sin(Φ) (See REF9). However, the passband ripple does not increase due to beam steering.

Optimization for M=2

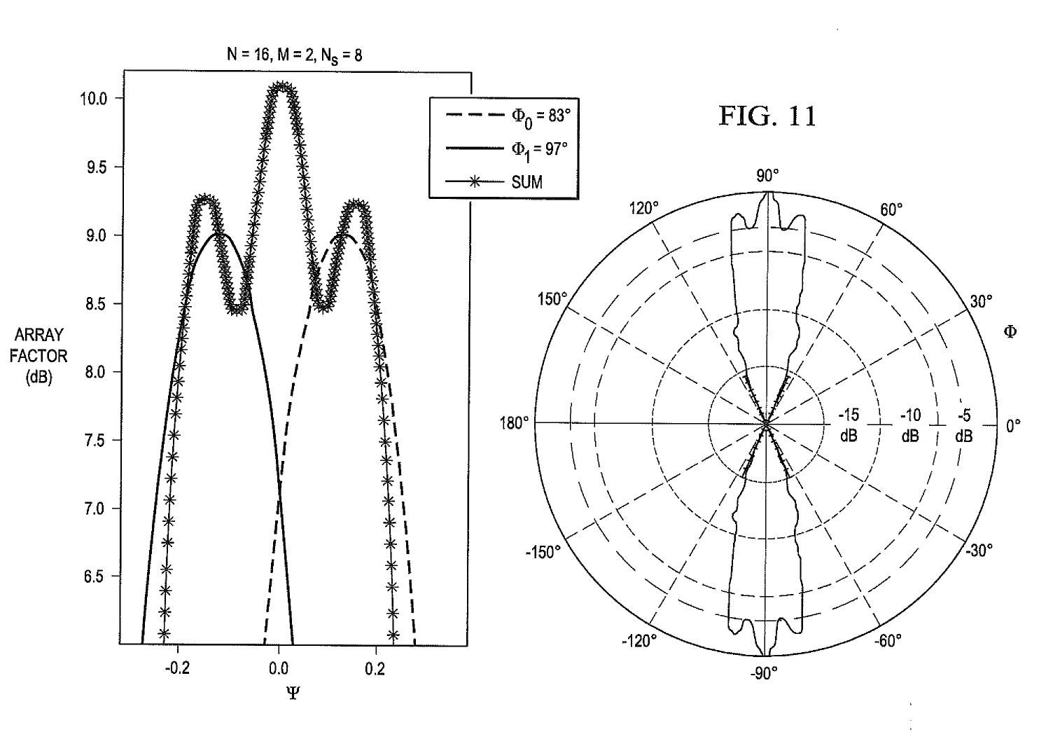

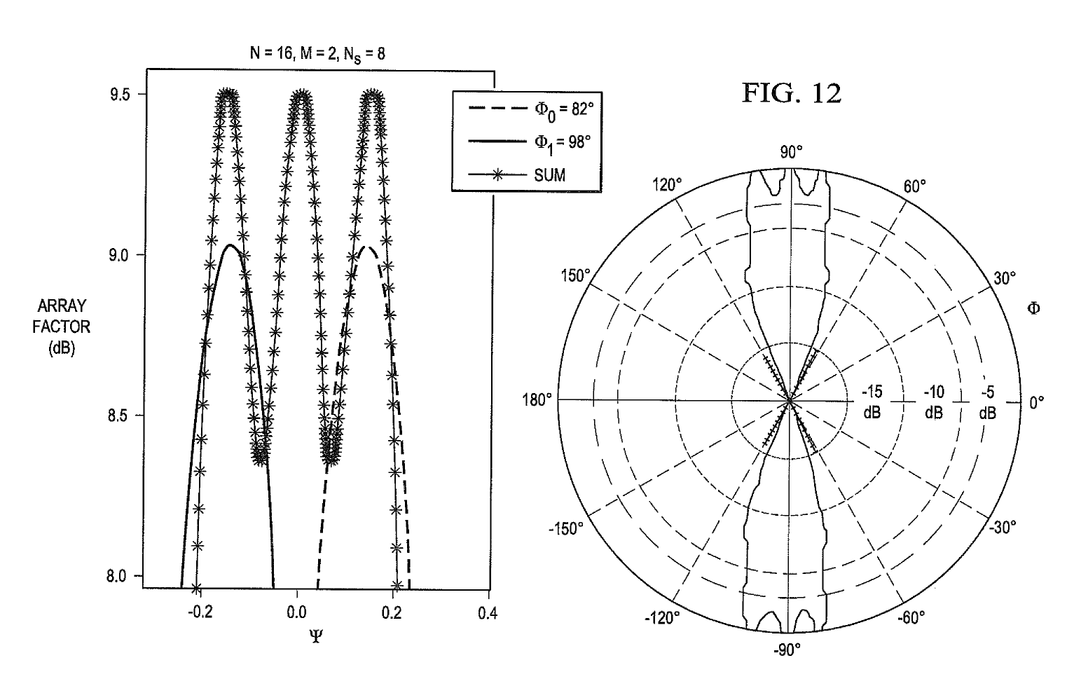

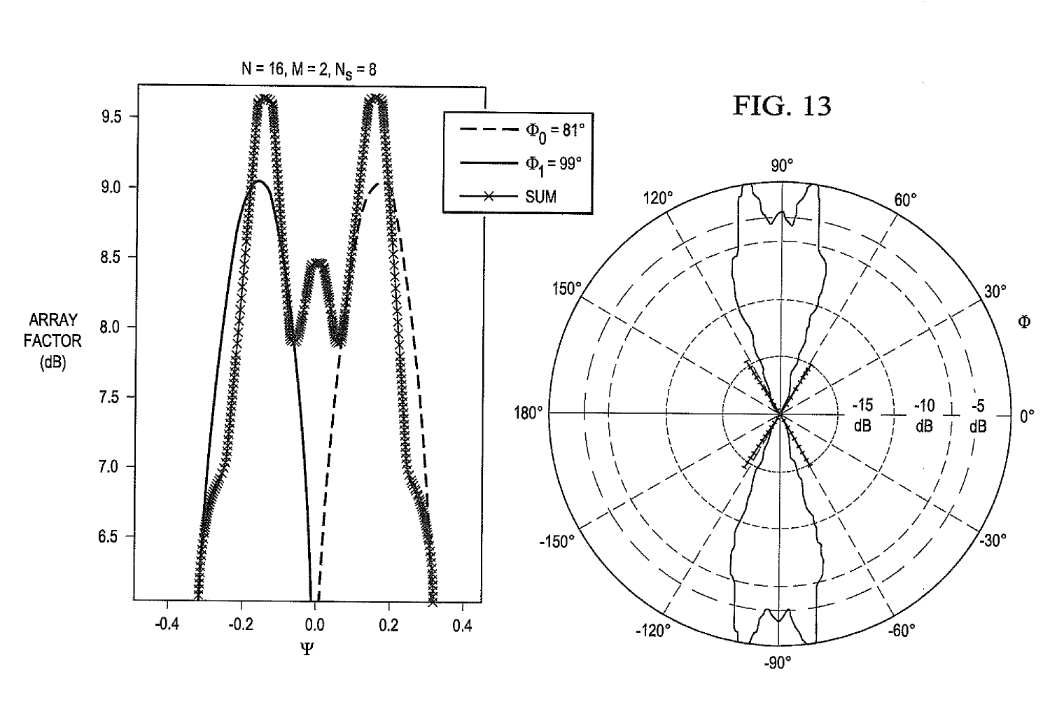

Although the ripple is most prominent for M=2, it is possible to optimize the ripple further for M=2 since there are only two beams. FIG. 11 illustrates the default ripple for a sixteen (16) element array with M=2 by placing the second sub-array beam at the minima of the first array. As shown in FIG. 11, the ripple peaks at ψ=0. FIG. 12 illustrates increasing the beam placement to achieve an optimum ripple. As shown in FIG. 12, as the beams are pushed further, the interaction between the beams reduces and we can see the ripple at ψ=0 becoming reduced and matching with the ripple at the edges, thereby providing an optimal ripple height at a specific beam direction. As shown in FIG. 13, further increasing the beam direction continues to decrease the ripple at ψ=0. However, the ripple due to the individual sub-arrays now starts to dominate the ripple and the beams essentially become two separate beams with increasing beam direction. The beam angle φ₀ for optimal ripple placement is given by:

$${φ}_{0} = {cos}^{- 1} ( \pm \frac{1.13 π}{{kdN}_{s}} ) ( M = 2 ) \qquad [ Eqn . 17 ]$$

Extensions to 2-D Antenna Arrays

Although the concepts described above focus on a one-dimensional (1-D) array for the purposes of illustration, the concepts may be extended to a two-dimensional (2-D) array in the XY plane. Instead of mapping the psi-space domain as Ψ=kd cos (Φ), the psi-space domain may be mapped as Ψ=kdₓ cos=(Φ)sin(θ)+kd_{y} sin(Φ)sin(θ), where θ is the elevation angle with respect to the Z-plane, and dₓ and d_{y} are the antenna spacing in the x and y directions respectively. REF11 explains that the antenna weight matrix for a 2-D array can be separated into two 1-D antenna array weights as:

A(θ,φ)=Aₓ(θ,φ)A_{y}(θ,φ) [Eqn. 18]

where Aₓ(θ,φ) and A_{y}(θ,φ) are the 1-D array responses in the x and y directions respectively.

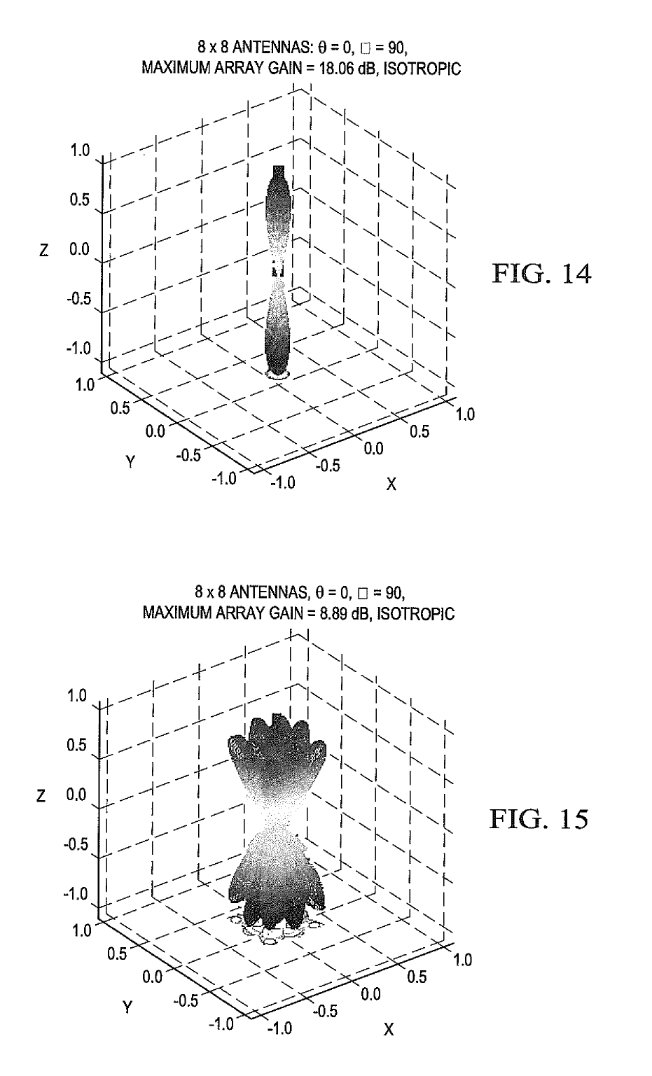

FIG. 14 illustrates a default array response for an 8×8 antenna array, providing an array gain of approximately 18 dB. FIG. 15 illustrates beam broadening for the 8×8 array using four (4) sub-arrays of 4×4 antennas. As shown in FIG. 15, there are three (3) peaks in each dimension, similar to the 1-D case for M=2. The beam is essentially broadened by a factor of sixteen (16) (4× in each direction) and the resultant array gain is approximately 9 dB.

A systematic approach to beam broadening for phased antenna arrays by using multiple sub-arrays has been described. This approach broadens the beam by M² and can provide beams with ripples less than approximately 3 dB, ensuring the half-power beam width in the main lobe. This design allows flexibility in broadening the shape of a beam or for designing multiple beams for a phased antenna array without requiring any amplitude control and without loss in power. Thus, flexible beam shapes for phased antenna arrays can be developed for mmWave mobile communication, allowing adjustment of the beam width to the characteristics of the channel and the system design.

The following embodiments apply the principles of beam-broadening by splitting an antenna array into groups, in the setting of a broadband communications network. The broadband communication network can be a centralized network, such as a cellular system, or a decentralized network, such as a peer-to-peer ad hoc network. Although many of the embodiments herein describe beam broadening in the context of a cellular network, those familiar with the art will recognize that the embodiments are broadly applicable in other wireless networks.

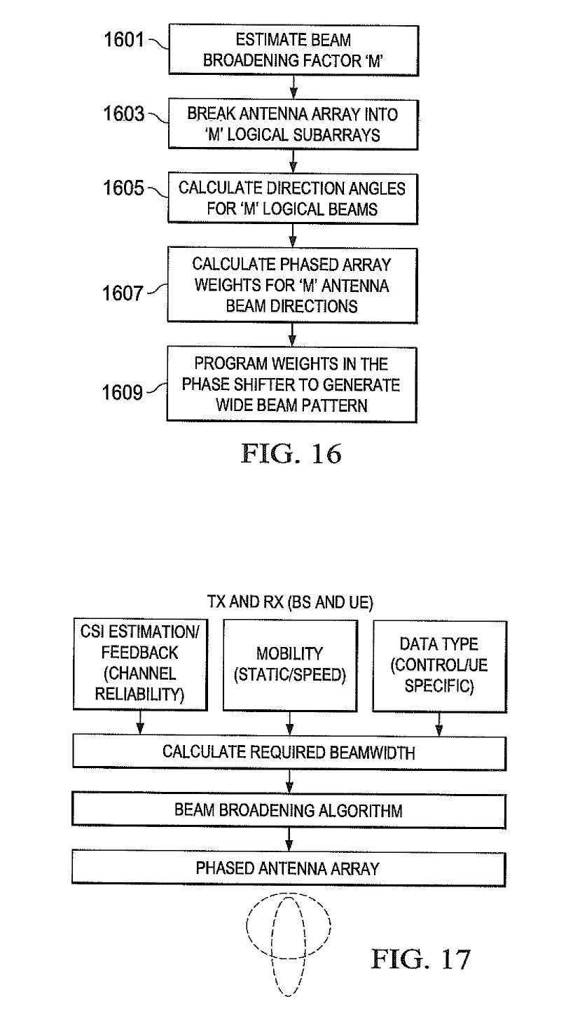

FIG. 16 illustrates a method associated with a beam broadening algorithm according to an embodiment of this disclosure.

In block 1601, the beam broadening factor ‘M’ is estimated for the current antenna array. For example, the broadening factor could be determined as given by equation (15). In block 1603, the array is divided into ‘M’ logical sub-arrays to achieve the required beam broadening factor.

In block 1605, the angular directions for the beams are computed. For example, the angular directions could be calculated as given by equation (11). In block 1607, the phased array weights are computed for the ‘M’ subarrays as shown in equation (3). In block 1609, the calculated weights are programmed into the phase shifters in order to generate the wide beam pattern.

FIG. 17 illustrates a procedure for beam broadening to be performed at the base station (BS) and mobile (UE), according to an embodiment of this disclosure. As shown in FIG. 17, the procedure may be performed for transmission or reception. The procedure may use any one or more of the following information as input(s):
Channel state information (CSI) estimate (if UE);
CSI feedback (if BS);
UE mobility;
Data type (control/broadcast or UE-specific data).

Based on the information, the action taken for beam broadening could be as follows. If it is determined that the channel is unreliable, then the beam width may be increased (resulting in a lower data rate). If the UE is mobile, then the beam width may be increased (depending on the speed of the UE). If control information is received from the BS, then the beam width may be increased to the maximum beam width for the current sector. The beam broadening could be dynamically calculated (based on CSI) or selected based on a multi-resolution codebook calculated a priori.

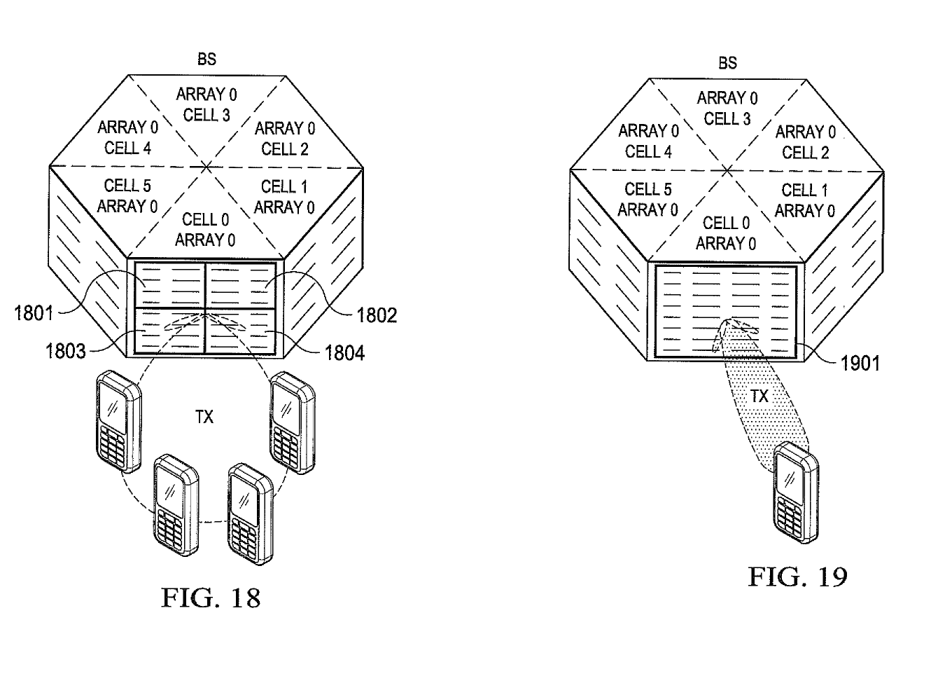

FIGS. 18 and 19 illustrate two example applications of antenna sub-arrays according to embodiments of this disclosure. The embodiments of the antenna sub-arrays illustrated in FIGS. 18 and 19 are for illustration only. Other embodiments of the antenna sub-arrays could be used without departing from the scope of this disclosure.

An antenna array may be split into M sub-arrays to broaden the beam to support a multicast or broadcast channel to a group of receivers or to all receivers, over a large area. As shown in FIG. 18, Array 0 in Cell 0 is split into four sub-arrays 1801-1804. The four sub-arrays 1801-1804 transmit a relatively broader beam for a multicast or broadcast channel to a number of receivers. In contrast, as shown in FIG. 19, the M sub-arrays can be combined to work as one large antenna array 1901 to beam-form data in a relatively narrow beam transmission to a specific receiver. In cellular networks, control channels are broadcast (or multicast) to all (or a group of) receivers, while unicast data for a given user is beam-formed to his receiver.

Since control channels are broadcast, their HPBW should be broad to cover most of the users. Because the antenna arrays at the transmitters are fixed, beam-broadening by splitting the array into multiple sub-arrays can achieve this target coverage by creating a broader beam using all antennas in the array. This beam broadening approach is preferable to broadening a beam by using only a subset of antennas in the array since no power is lost due to “turned off” antennas. The same antenna array can be used to beam-form a narrow beam to a particular receiver for a unicast transmission. This beam-broadening approach provides flexibility for using an antenna array to support different beam-widths based on the underlying data to be transmitted.

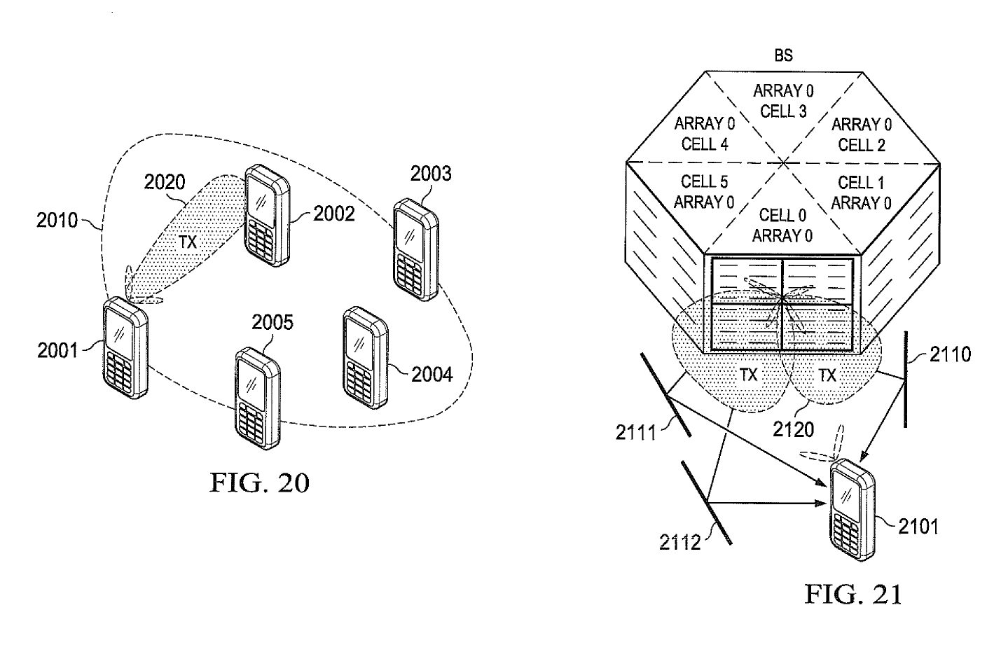

FIG. 20 illustrates an example of a beam broadening application for a beacon transmission according to an embodiment of this disclosure. The embodiment of the beacon transmission illustrated in FIG. 20 is for illustration only. Other embodiments of the beacon transmission could be used without departing from the scope of this disclosure.

As shown in FIG. 20, beam broadening by splitting an antenna array into multiple sub-arrays can be used to improve the coverage of beacon signals in peer-to-peer communication. Peer-to-peer communications are arranged on an ad hoc basis by transmitters and receivers. There are two distinct operations in peer-to-peer transmission-device discovery and data transmission. In device discovery, a transmitter transmits a beacon signal which is received by all receivers, which then inform the transmitter of their presence. Thus, for device discovery, it is beneficial for the beam to be broad enough to reach the maximum number of receivers.

As an example, in the arrangement shown in FIG. 20, a transmitter 2001 is in communication with a plurality of receivers 2002-2005. For beacon transmissions to multiple receivers, the transmitter 2001 uses beam broadening to transmit on a wider beam 2010. In contrast, for data transmissions to a single receiver 2002, the transmitter 2001 transmits on a narrow beam.

In accordance with another embodiment of this disclosure, an antenna array is split into M sub-arrays to broaden the beam. The split is based on feedback from the receiver or a group of receivers, so that the array may be optimized for transmission to the receiver. The number of groups into which the antenna is split may be varied to achieve a specific level of broadening, as determined by the feedback from the receiver.

For example, FIG. 21 illustrates an application of beam broadening to support multiple ray reception at a receiver, in accordance with an embodiment of this disclosure. The embodiment of the beam broadening illustrated in FIG. 21 is for illustration only. Other embodiments of beam broadening could be used without departing from the scope of this disclosure.

As shown in FIG. 21, a receiver 2101 is surrounded by a number of reflectors 2110-2112 in the receiver's vicinity. Each reflector may be a building, wall, geographical feature, or any other object that tends to reflect transmitted signals. In an embodiment, the antenna array transmits a wide beam 2120 so that the receiver 2101 may collect multiple rays reflected from the reflectors 2110-2112 to improve the quality of the received signal. The number, location, and orientation of the reflectors 2110-2112 may be used to determine the weights and factors for the wide beam 2120. In contrast, if the receiver 2101 moves to a location with a line-of-sight path to the transmitter with few or no reflectors in the vicinity, then the transmitter may determine that it is advantageous to transmit a narrow beam to the receiver 2101.

The extent to which a beam is broadened can be determined by the number of rays received at the receiver. The number of rays received at the receiver can be determined and provided to the transmitter. Then, the number of received rays can be used at the transmitter to determine the beam broadening factor for the transmissions.

The receiver estimates channel parameters that include the number of rays received (which is the number of copies of the transmitted signal received), their delays and angle of arrival. The receiver then transmits the channel parameters to the transmitter. In cellular systems, this is known as channel state information feedback from the mobile station to the base station. Using the channel state information, the transmitter can determine the best transmit beam to maximize the data rate to the receiver.

In accordance with an embodiment of this disclosure, beam broadening can be applied to determine a codebook with different beam widths for a specific antenna configuration. The transmitter can select beams with varying beam widths so that the transmitter can support different types of traffic, coverage or data rate requirements. For example, beam widths may be determined based on system level information (e.g., time of day, system capacity, coverage area, transmission power), type of data (e.g., broadcast, multicast, or unicast data), occurrence of events (such as a sporting event), and the like. Additionally or alternatively, beam widths may be determined based on receiver-specific information, e.g., speed and direction of movement, required downlink capacity, signal to noise ratio at the receiver, channel fading, and the like. In some embodiments, the beam widths may be based on the channel feedback from the receiver. In response to the channel feedback, the transmitter can select a specific beam in order to optimize performance for the requirement. The specific beam patterns and their associated beam broadening vectors could comprise a finite number of parameters that are stored in a codebook in the transmitter's memory.

Thus, the finite beam-broadening parameters may be fixed and stored in a codebook that is known to the transmitter and the receiver. Instead of actually feeding back the channel state values (i.e., the number of rays, etc.) to the transmitter, the receiver can merely select and transmit to the transmitter an index associated with the best beam from the codebook for the estimated channel, thus saving valuable feedback resources.

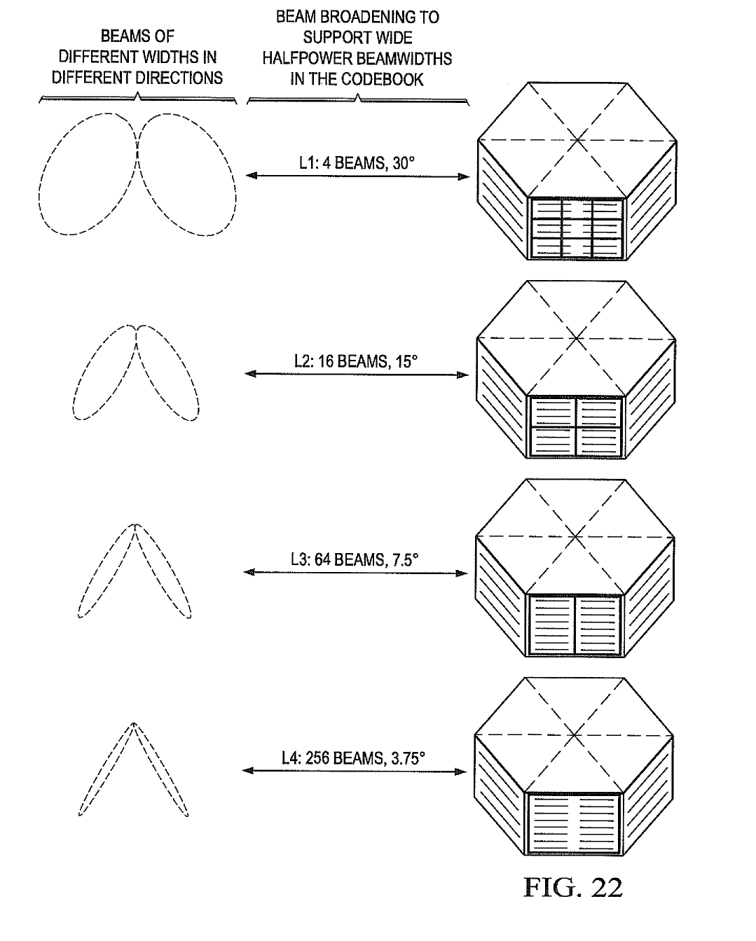

For example, FIG. 22 illustrates an arrangement in which different beam widths are supported in a codebook, in accordance with an embodiment of this disclosure. As shown in FIG. 22, four (4) different half power beam width resolution levels (L1 through L4) are provided via beam broadening. L1 provides, for example, 4 beams of 30 degrees each to cover a given area, while L2 provides 16 beams of 15 degrees each, L3 provides 64 beams of 7.5 degrees each, and L4 provides 256 beams of 3.75 degrees each. It is possible that the beams in the codebooks have some overlap to provide high gain values for all directions. Those skilled in the art will understand that these values are merely for the purpose of example. Other values in other beam width resolution levels are possible.

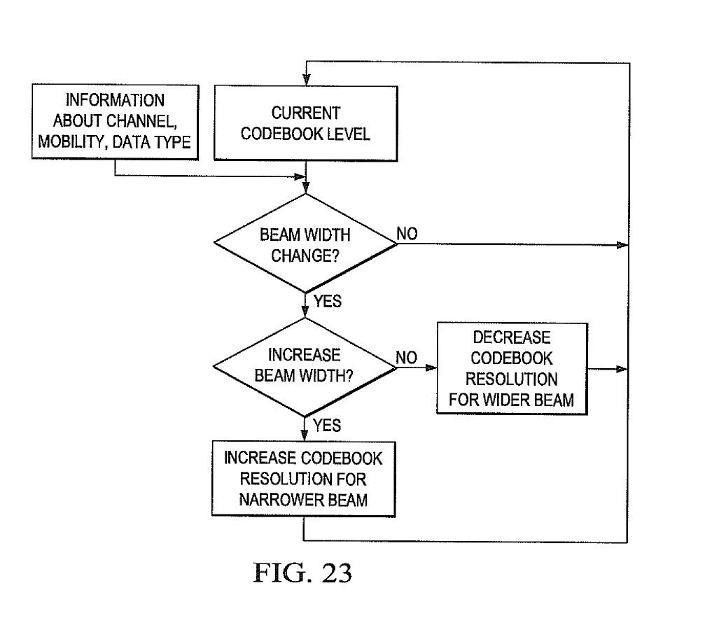

FIG. 23 illustrates a codebook selection procedure in accordance with one embodiment of this disclosure. The different codebook levels can be selected based on the procedure outlined in FIG. 23. Based on the information such as the mobility of the UE, the channel state information, and the type of data (control/broadcast or UE-specific), the base-station and mobile station may increase or decrease the resolution of the codebook to widen or narrow the beam for transmission and reception.

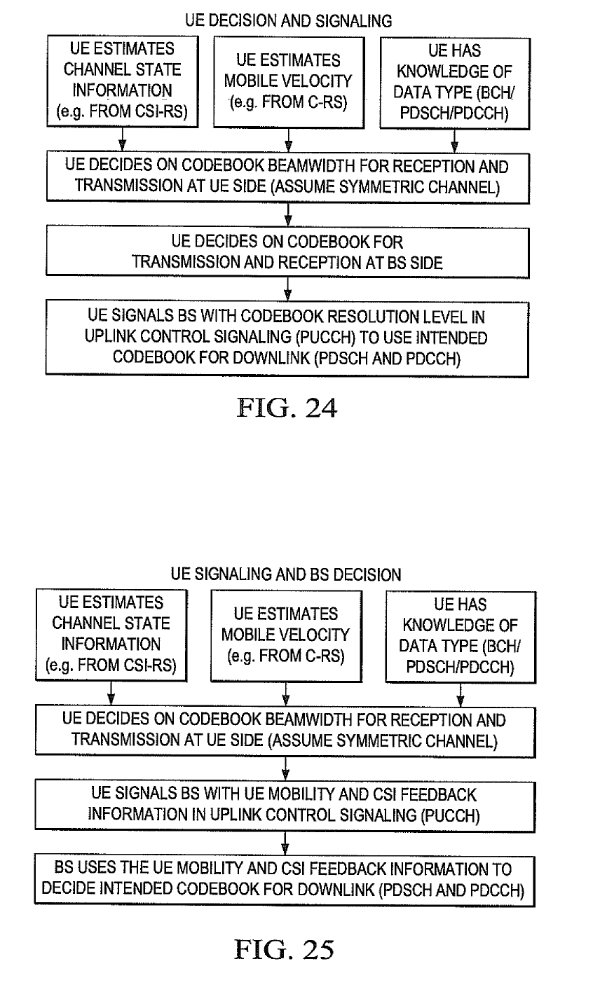

FIG. 24 illustrates a codebook selection procedure with UE decision and signaling, in accordance with one embodiment of this disclosure. As shown in FIG. 24, the codebook selection procedure for the BS and UE may be performed at the UE and the signaling could be given to the BS to help determine the codebook resolution for transmission to the specific UE. For example, assuming LTE standard terminology, the channel state information could be estimated based on the channel state information reference signal (CSI-RS signal) and the mobile velocity could be estimated based on the common reference signal (C-RS signal). The UE is already aware of whether the BS is transmitting control or data information. Based on this information, the UE selects the codebook to be used for its optimal transmission and reception. The UE can also select the codebook that the BS should use for transmission based on its view of the channel and its mobility. The UE can then request the BS to select the right codebook resolution for transmission and reception using the physical uplink control channel (PUCCH). The codebook level selection could be part of the PUCCH message.

FIG. 25 illustrates a codebook selection procedure with UE signaling and BS decision, in accordance with one embodiment of this disclosure. As shown in FIG. 25, the UE continues to make its own selection for the codebook resolution for downlink reception and uplink transmission. The UE sends the information about CSI-RS and the mobile velocity to the BS in its PUCCH. The BS then makes the selection on the codebook resolution to be used for downlink transmission and uplink reception.

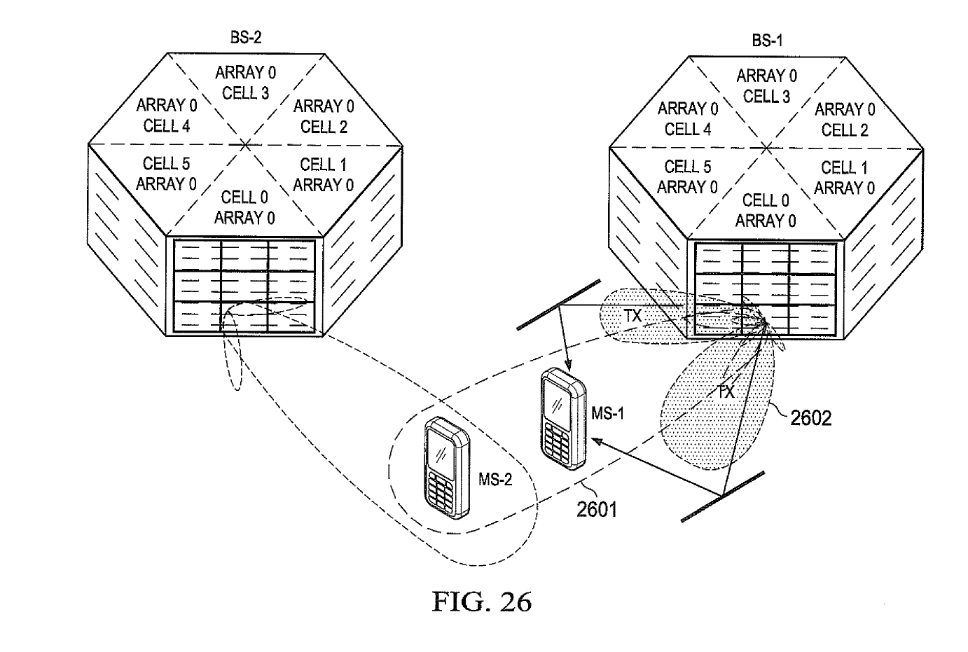

FIG. 26 illustrates an application of spectral null placement by beam broadening, in accordance with an embodiment of this disclosure. This allows the transmitter to avoid interference to unintended receivers in a particular direction by using a beam broadening procedure.

As illustrated in FIG. 26, base station BS-1 is in communication with mobile station MS-1 and base station BS-2 is in communication with mobile station MS-2. If the base station BS-1 transmits to the mobile station MS-1 using a narrow beam 2601, the narrow beam 2601 may extend far enough to interfere with the mobile station MS-2's reception of the transmission from the base station BS-2.

In this situation, beam broadening by splitting an antenna array into multiple groups can be used for strategically placing nulls in specific spatial directions while maintaining coverage over a specified area. That is, a transmitter may use a control mechanism to place a null over the direction of an interfered second receiver, such that its interference is mitigated. A null means that no energy is radiated in the direction of the interfered receiver. This can be used for interference mitigation in general and to enable multi-cell cooperation in cellular systems and the like.

For example, as shown in FIG. 26, sub-arrays in the base station BS-1 may be used to produce broader beams 2602 that transmit on paths in different spatial directions other than the interfering direction to transmit data to the mobile station MS-1. A spectral null is produced in the direction of the mobile station MS-2.

The embodiment of the spectral null placement illustrated in FIG. 26 is for illustration only. Other embodiments of the spectral null placement could be used without departing from the scope of this disclosure. For example, a receiver may use spectral null placement to mitigate interference due to transmissions from multiple transmitters.

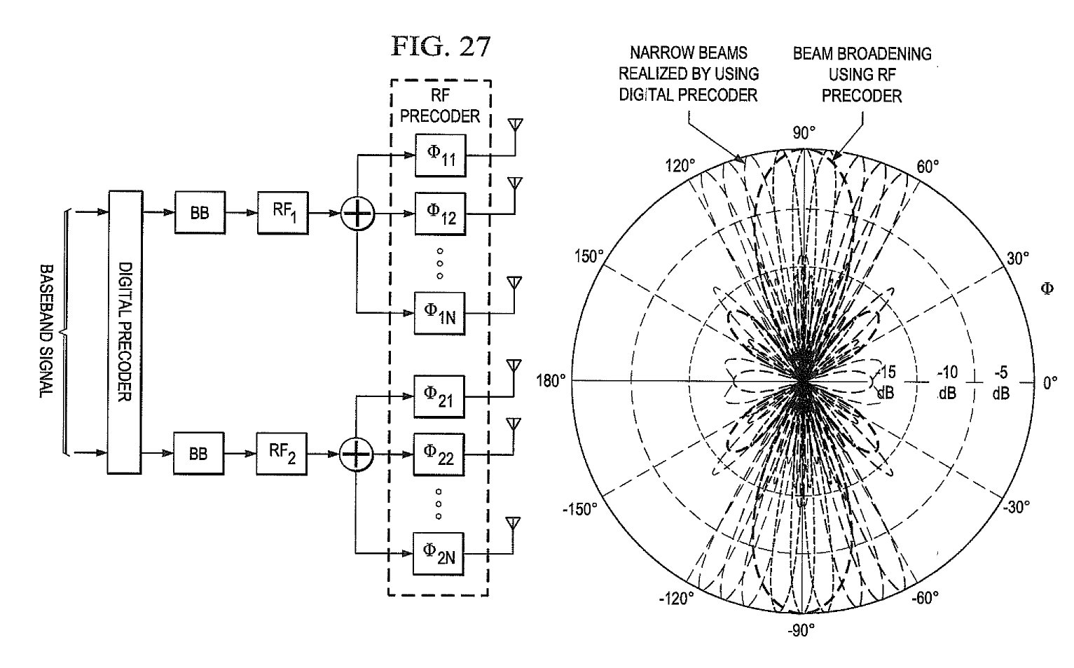

FIG. 27 illustrates the use of a digital precoder to refine beams while sub-arrays are used for beam broadening, in accordance with an embodiment of this disclosure. As shown in FIG. 27, two RF chains provide narrow beams using digital beamforming within the broad beam generated by the RF beamforming. Each sub-array is connected to a different RF chain and the system includes a baseband precoder. The sub-arrays provide a broad beam using the beam broadening algorithm and the baseband precoder can be used to provide fine beams within the broad beam defined by the sub-arrays.

The digital baseband precoder's speed is used for quick spatial refinement, while the sub-arrays are used to determine a beam with a larger half power beam width that is updated at a slower rate.

In an embodiment, the RF beamforming using sub-arrays can be updated at a slower rate for long-term beamforming since the RF beam may not be changed rapidly due to hardware constraints. In contrast, the digital base-band precoder can be updated rapidly for short-term beamforming, for example, to adapt to the user's mobility. The digital precoder may also be used for beamforming on a sub-carrier frequency basis.

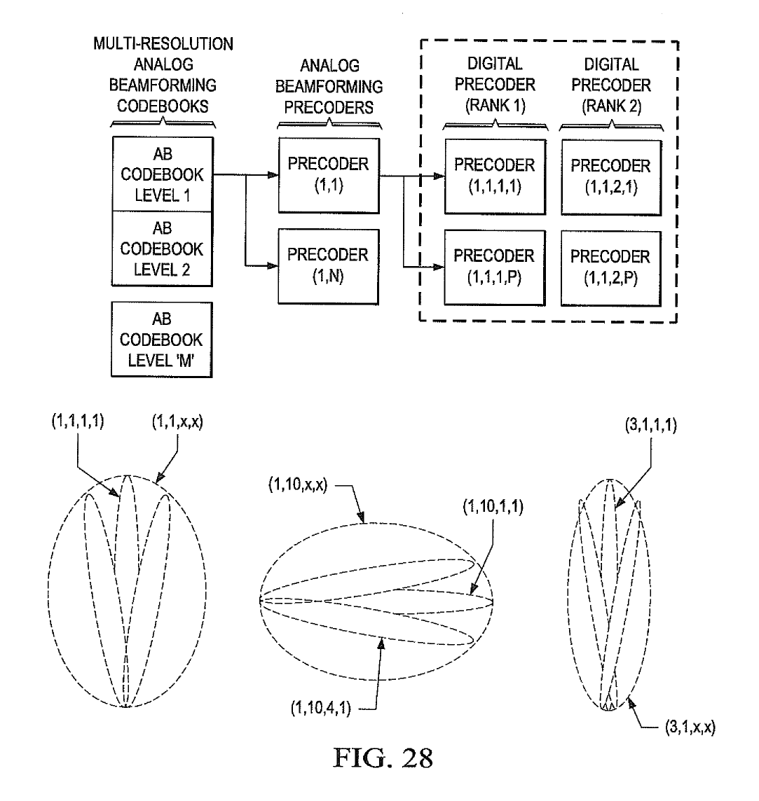

FIG. 28 illustrates a multi-resolution codebook structure and associated feedback, in accordance with an embodiment of this disclosure. There are two types of codebooks for beamforming: analog beamforming codebooks and digital beamforming codebooks. Both the analog and digital beamforming codebooks may be composed of multiple levels of beam resolution. These codebooks could be implemented in multiple arrangements.

In one implementation, for each analog codebook level, there are multiple analog precoders to cover different directions with each beam width resolution. For each of these precoders, there is a corresponding set of digital precoders (which may support multiple channel ranks or multiple subcarrier frequencies). In another implementation, there may be two sets of precoders for analog and digital precoding. Depending on the analog precoder, a different subset of digital precoders may be used.

FIG. 28 shows how the analog and digital precoders can be constructed. There can be ‘M’ levels of the analog beamforming codebook corresponding to different beam widths. Within each level, there could be ‘N’ precoders for different directions. For each of these ‘N’ analog precoders, there could be corresponding ‘P’ digital precoders for different channel ranks or different subcarrier frequencies.

FIG. 29 illustrates the frequency of precoder updates, in accordance with an embodiment of this disclosure. As shown in FIG. 29, not all precoders are sent every time. The analog precoder is updated on a slower basis and the digital precoder is updated more frequently. Hence, the entire index need not be sent at once and the analog precoding index can be sent infrequently.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting a signal to at least one receiver using multiple beam widths, the method comprising:
determining a first beamforming weight associated with a total number of antennas in an antenna array;
transmitting a first signal in a first beam having a first beam width using the total number of antennas by applying the first predetermined beamforming weight;
determining a second beamforming weight associated with a first sub-array of antennas in the antenna array and determining a third beamforming weight associated with a second sub-array of antennas in the antenna array;
transmitting a second signal in a second beam having a second beam width using the first sub-array of antennas by applying the second beamforming weight and the second sub-array of antennas by applying the third beamforming weight.

2. The method of claim 1, wherein the first signal is transmitted in a narrow beam, and the second signal is transmitted in a wider beam using all of the antennas in the antenna array.

3. The method of claim 1, wherein transmitting the second signal in the second beam comprises:
determining a transmission direction of the second beam;
orienting the first and second sub-arrays in different directions, such that a net orientation of the sub-arrays is in the transmission direction of the second beam with the second beam width.

4. The method of claim 1, wherein determining each of the first, second, and third beamforming weights comprises selecting a predetermined beamforming weight from a codebook.

5. The method of claim 1, wherein the second and third beamforming weights are determined based on channel feedback received from at least one receiver.

6. The method of claim 1, wherein the second and third beamforming weights are determined based on a direction of arrival or departure of the second signal at at least one reflector that reflects the second signal.

7. The method of claim 1, wherein the second signal is transmitted to a first receiver and the second and third beamforming weights are determined such that the second beam comprises a null in a direction of a second receiver so as to mitigate interference at the second receiver.

8. The method of claim 1, wherein each of the first, second, and third beamforming weights is associated with a different codebook, and each of the different codebooks is associated with one or more analog and digital precoders.

9. The method of claim 8, wherein the analog precoders are associated with wider beams and the digital precoders are associated with narrow beams, the method further comprising:
updating at least one of the digital precoders at a first frequency and updating at least one of the analog precoders at a second frequency, wherein the first frequency is more frequent than the second frequency.

10. For use in a wireless network, a transmitter capable of communicating with a plurality of receivers, the transmitter comprising:
an antenna array comprising a plurality of antennas; and
a transmit path configured to:
determine a first beamforming weight associated with a total number of antennas in the antenna array;
transmit a first signal in a first beam having a first beam width using the total number of antennas by applying the first predetermined beamforming weight;
determine a second beamforming weight associated with a first sub-array of antennas in the antenna array and determine a third beamforming weight associated with a second sub-array of antennas in the antenna array;
transmit a second signal in a second beam having a second beam width using the first sub-array of antennas by applying the second beamforming weight and the second sub-array of antennas by applying the third beamforming weight.

11. The transmitter of claim 10, wherein the first signal is transmitted in a narrow beam, and the second signal is transmitted in a wider beam using all of the antennas in the antenna array.

12. The transmitter of claim 10, wherein the transmit path is configured to transmit the second signal in the second beam by:
determining a transmission direction of the second beam;
orienting the first and second sub-arrays in different directions, such that a net orientation of the sub-arrays is in the transmission direction of the second beam with the second beam width.

13. The transmitter of claim 10, wherein the transmit path is configured to determine each of the first, second, and third beamforming weights by selecting a predetermined beamforming weight from a codebook.

14. The transmitter of claim 10, wherein the transmit path is configured to determine the second and third beamforming weights based on channel feedback received from at least one receiver.

15. The transmitter of claim 10, wherein the transmit path is configured to determine the second and third beamforming weights based on a direction of arrival or departure of the second signal at at least one reflector that reflects the second signal.

16. The transmitter of claim 10, wherein the transmit path is configured to transmit the second signal to a first receiver and determine the second and third beamforming weights such that the second beam comprises a null in a direction of a second receiver so as to mitigate interference at the second receiver.

17. The transmitter of claim 10, wherein each of the first, second, and third beamforming weights is associated with a different codebook, and each of the different codebooks is associated with one or more analog and digital precoders.

18. The transmitter of claim 17, wherein the analog precoders are associated with wider beams and the digital precoders are associated with narrow beams, the transmit path further configured to:
update at least one of the digital precoders at a first frequency and update at least one of the analog precoders at a second frequency, wherein the first frequency is more frequent than the second frequency.

19. For use in a wireless network, a receiver capable of communicating with a plurality of transmitters, the receiver comprising:
an antenna array comprising a plurality of antennas; and
a receive path configured to:
determine a first beamforming weight associated with a total number of antennas in the antenna array;
receive a first signal in a first beam having a first beam width using the total number of antennas by applying the first predetermined beamforming weight;
determine a second beamforming weight associated with a first sub-array of antennas in the antenna array and determine a third beamforming weight associated with a second sub-array of antennas in the antenna array;
receive a second signal in a second beam having a second beam width using the first sub-array of antennas by applying the second beamforming weight and the second sub-array of antennas by applying the third beamforming weight.

20. The receiver of claim 19, wherein the first signal is received in a narrow beam, and the second signal is received in a wider beam using all of the antennas in the antenna array.

21. The receiver of claim 19, wherein the receive path is configured to receive the second signal in the second beam by:
determining a reception direction of the second beam;
orienting the first and second sub-arrays in different directions, such that a net orientation of the sub-arrays is in the reception direction of the second beam with the second beam width.

22. The receiver of claim 19, wherein the receive path is configured to determine each of the first, second, and third beamforming weights by selecting a predetermined beamforming weight from a codebook.

23. The receiver of claim 19, wherein the receive path is configured to determine the second and third beamforming weights based on the channel estimated at the receiver from the transmission from at least one transmitter.

24. The receiver of claim 19, wherein the receive path is configured to determine the second and third beamforming weights based on a direction of arrival or departure of the second signal at at least one reflector that reflects the second signal.

25. The receiver of claim 19, wherein the receive path is configured to receive the second signal from a first transmitter and determine the second and third beamforming weights such that the second beam comprises a null in a direction of a second transmitter so as to mitigate interference at the second transmitter.

26. The receiver of claim 19, wherein each of the first, second, and third beamforming weights is associated with a different codebook, and each of the different codebooks is associated with one or more analog and digital precoders.

27. The receiver of claim 26, wherein the analog precoders are associated with wider beams and the digital precoders are associated with narrow beams, the receive path further configured to:
update at least one of the digital precoders at a first frequency and update at least one of the analog precoders at a second frequency, wherein the first frequency is more frequent than the second frequency.
